(19) United States
(12) Patent Application Publication
(10) Pub. No.: US 2012/0256801 A1
(43) Pub. Date: Oct. 11, 2012

(54) RADIO WAVE RECEIVING APPARATUS AND POSITION CALCULATING METHOD

(75) Inventor: Hideto SHIBOHTA, Tokyo (JP)

(73) Assignee: NEC CORPORATION, Tokyo (JP)

(21) Appl. No.: 13/530,224

(22) Filed: Jun. 22, 2012

Related U.S. Application Data
(62) Division of application No. 12/672,621, filed on Feb. 8, 2010.

(30) Foreign Application Priority Data
Sep. 13, 2007 (JP) 2007237425

(51) Int. Cl. H01Q 3/02; H01Q 1/42

(52) U.S. Cl. 343/757; 343/872

(57) ABSTRACT

A radio wave receiving apparatus includes a plurality of antennas disposed on a circuit board, the plurality of antennas having radiation patterns with different bearings and which indicate a directivity of said antennas upon receipt of radio waves, a storage unit for storing information of the radiation patterns of the plurality of antennas, a detector for detecting a change in the attitude of the circuit board, and a controller for determining a distribution ratio for reception signals received by the plurality of antennas based on the information stored in the storage unit which corresponds to the attitude of the circuit board detected by the detector.

### REFERENCE TO RELATED APPLICATION

This is a divisional application of U.S. patent application Ser. No. 12,672,621 filed on Feb. 8, 2010 and claims the benefit of its priority.

### TECHNICAL FIELD

The present invention relates to a radio wave receiving apparatus and a position calculating method which are suitable for use in GPS (Global Positioning System).

### BACKGROUND ART

A GPS is a three-dimensional positioning system for identifying the present position of a user using radio waves from a plurality of artificial satellites (hereinafter referred to as GPS satellites) orbiting around the earth. The GPS uses a GPS receiver for calculating its own position based on map data preset therein and received GPS signals. The GPS receiver is installed in a terminal such as a cellular phone or the like and can also be used for navigation. The terminal with the GPS receiver installed therein can be used to report emergencies such as incidents and accidents because its position can easily be transmitted to someone that the terminal has called. In the U.S., there has been proposed a system wherein a GPS receiver is installed in a CDMA (Code Division Multiple Access) cellular phone and when it makes a call in E-911 (Enhanced 911: enhanced emergency call system), the position of the caller is identified using the GPS. It has also been considered to use terminals with GPS receivers installed therein for logistics monitoring and location monitoring for pets, etc. Accordingly, there is a need for smaller and lighter GPS receivers.

To fulfil the positioning function of the GPS, it is necessary for a GPS receiver to be able to receive GPS signals from GPS satellites. Consequently, the antenna of the GPS receiver requires a high gain. Since the terminal which incorporates the GPS receiver needs to be smaller and lighter, the antenna is also required to be smaller. GPS antennas thus need to be designed for a higher gain as well as a smaller size and a thinner configuration.

Inasmuch as a GPS receiver is required to simultaneously receive radio waves from a plurality of GPS satellites, the antenna thereof should desirably have a gain that is as uniform as possible around the communication terminal which incorporates the GPS receiver (omni-directional).

However, it is theoretically infeasible to realize an antenna that is omnidirectional in a strict sense. An antenna necessarily suffers gain differences depending on the direction (bearing). Any antennas which are nearly ideally omnidirectional have their gains reduced in all directions.

In the present specification, the terms “omnidirectional antenna” and “directional antenna” will be used. They mean an antenna whose directivity is relatively weak (wide) and an antenna whose directivity is relatively strong (narrow), respectively. An omnidirectional antenna mentioned herein does not refer to an ideally omnidirectional antenna.

In car navigation systems which utilize a GPS, an antenna having a relatively high gain in a wide angle in the sky may be selected and mounted on a vehicle for receiving GPS signals from a plurality of GPS satellites. For example, a patch antenna comprising a thin dielectric substrate with a metal film disposed on one surface thereof and an antenna element of strip structure disposed on the other surface thereof has a directivity in a wide angle with respect to a direction that is perpendicular to the surface on which the antenna element is disposed (main radiating surface). If a patch antenna is mounted on a vehicle parallel to the ground such that the main radiating surface faces the sky, then it can easily receive GPS signals irrespective of the direction of the vehicle.

In the present specification, the patch antenna will be illustrated as an omnidirectional antenna by way of example. On the other hand, an inverted-F antenna, though it is planar just like the patch antenna, is strongly directional and has different reception sensitivities for receiving GPS signals from the GPS satellites depending on the bearing even though the inverted-F antenna is mounted on a vehicle with its plane parallel to the ground. In the present specification, the inverted-F antenna will be illustrated as a directional antenna by way of example.

Apparatuses which utilize a GPS, e.g., vehicles incorporating a car navigation system, rarely move through large angles away from directions parallel to the ground. Consequently, once an omnidirectional antenna such as a patch antenna or the like is mounted on a vehicle parallel to the ground, it will essentially require no subsequent positional adjustments. In addition, since the patch antenna has a semicircular radiation pattern which is directional only in the main radiating surface, it has no wasted directivity toward the ground and hence has a very high gain. Therefore, the patch antenna is widely used as small antennas for use on apparatuses which utilize a GPS.

Portable terminals which are small and designed for portability, such as cellular phones, PHS (Personal Handy phone Systems) sets, or PDAs (Personal Digital Assistants), have their body attitude changeable depending on how they are used.

If a planar antenna such as a patch antenna is installed on the body of such a portable terminal, then since the attitude of the antenna also changes with the body, there will be occasions when the antenna can sometimes easily receive radio waves from the GPS satellites and occasions when the antenna sometimes fails to receive radio waves from the GPS satellites. In a system such as E-911, therefore, the terminal of the caller may not be able to receive radio waves from the GPS satellites, and hence its position may not be determined.

A technology for switching, with a switch, between a plurality antennas disposed in different positions on a foldable cellular phone is disclosed in Japanese Laid-Open Patent Application No. 2002-354073, for example. The technology disclosed in Japanese Laid-Open Patent Application No. 2002-354073 will hereinafter be referred to as first background art.

The cellular phone according to the first background art has an upper lid having a display, etc. and a lower casing having operating keys, etc. A pole antenna shared for CDMA wireless communications and a GPS is disposed in an end of the lower casing near its hinge. The cellular phone according to the first background art also has a planar GPS antenna disposed in a given position on the surface of the lower casing or the upper lid.

FIG. 1 is a perspective view showing a structure of the cellular phone according to the first background art. FIG. 1 shows cellular phone 100 with upper lid 101 in an open state and lower casing 102 held by hand 103. With such foldable cellular phone 100, when upper lid 101 is opened, the antenna disposed in the end of lower casing 102 near hinge 104 is covered by upper lid 101. In FIG. 1, the antenna shared for CDMA wireless communications and a GPS is omitted from illustration. Therefore, foldable cellular phone 100 shown in FIG. 1 has a problem in that when upper lid 101 is open, the shared antenna disposed in the end of lower casing 102 near hinge 104 does not lend itself to receiving radio waves from the GPS satellites.

According to the first background art, an antenna for a GPS (GPS antenna 106) which comprises a patch antenna is disposed near display 105 of upper lid 101, and when upper lid 101 is open, a switch, not shown, is used to switch to GPS antenna 106 for receiving GPS signals.

When upper lid 101 is closed, GPS antenna 106 is covered by upper lid 101. However, the shared antenna disposed in the end of lower casing 102 near hinge 104 is exposed. Therefore, when upper lid 101 is closed, the non-illustrated switch is used to switch to the shared antenna to receive GPS signals.

The first background art shows that the two antenna are selected one at a time depending only on whether or not upper lid 101 shown in FIG. 1 is an obstacle to the reception of GPS signals, and does not take the directivity of the antennas into consideration. The user needs to adjust the attitude and bearing of cellular phone 100 for better reception of GPS signals, giving rise to a problem in that the usage of cellular phone 100 is limited when it utilizes a GPS.

Adjusting the inclination of an antenna for better reception of GPS signals is disclosed in Japanese Laid-Open Patent Application No. 2004-336458, for example. The technology disclosed in Japanese Laid-Open Patent Application No. 2004-336458 will hereinafter referred to as second background art.

An antenna apparatus according to the second background art comprises a first movable member which holds a holding member with a planar antenna mounted thereon, a second movable member by which the first movable member is rotatably supported for rotation through an angle of elevation, and a casing by which the second movable member is rotatably supported for rotation in an azimuthal direction. The second movable member can stop the first movable member against rotation at a certain angle of elevation, and the casing can stop the second movable member against rotation at a certain azimuthal angle.

According to the second background art, it is possible to adjust the angle of elevation and the bearing of the antenna separately. Therefore, the antenna can be changed to an optimum orientation according to various situations in which it is used.

The antenna apparatus according to the second background art includes a mechanism for adjusting the angle of elevation and the bearing of the antenna. The mechanism comprises a rotational shaft mounted on the inner wall of a hollow cylindrical case. The holding member with the planar antenna mounted thereon is swingably mounted on the rotational shaft, and the hollow cylindrical case is mounted on the rotational shaft for rotation about its central axis. For allowing the holding member to swing in a large angular range, the hollow cylindrical case needs to be large. Consequently, the antenna apparatus according to the second background art needs a complex mechanism for adjusting the angle of elevation and the bearing of the antenna, and the overall apparatus, which includes actuators and sensors for the mechanism, tends to be large in size. Furthermore, the antenna apparatus according to the second background art is expensive because of the complex mechanism used. Therefore, it is difficult for the antenna apparatus according to the second background art to be incorporated in portable terminals that are small and relatively inexpensive.

Another problem is that if a planar antenna such as a patch antenna or the like is mounted on the surface of the body of a terminal such as a cellular phone or the like, then it tends to limit the layout of the display and operating keys.

### SUMMARY

It is an object of the present invention to provide a radio wave receiving apparatus and a position calculating method which are capable of easily receiving radio waves regardless of the attitude of an apparatus on which the radio wave receiving apparatus is mounted, without adversely affecting the layout of parts on the surface of the body of the apparatus.

In an aspect of the present invention for achieving the above-described object, a radio wave receiving apparatus according to the present invention comprises:

a plurality of antennas disposed on a circuit board, said plurality of antennas having radiation patterns with different bearings and which indicate a directivity of said antennas upon receipt of radio waves;

a storage unit for storing information of said radiation patterns of said plurality of antennas;

a detector for detecting a change in the attitude of said circuit board; and a controller for determining a distribution ratio for reception signals received by said plurality of antennas based on the information stored in said storage unit which corresponds to the attitude of said circuit board detected by said detector.

A position calculating method according to an aspect of the present invention comprises:

reading information of azimuths and angles of tilt of a plurality of radio wave transmission sources, which are stored in advance in a storage unit;

controlling the attitude of an antenna to bring the directivity of the antenna into alignment with the azimuths of said radio wave transmission sources, using the read information;

selecting a plurality of GPS signals having signal to noise ratios equal to or greater than a predetermined threshold value, from among GPS signals received from said radio wave transmission sources by said antennas; and

calculating a present position using the selected GPS signals.

### BRIEF DESCRIPTION OF THE DRAWINGS

FIG. 1 is a perspective view showing a structure of a radio wave receiving apparatus according to the first background art.

FIG. 2 is a perspective view showing an example of the appearance of a radio wave receiving apparatus according to a first exemplary embodiment.

FIG. 3 is a perspective view showing the manner in which a rotational member shown in FIG. 2 is rotated 90 degrees.

FIG. 4 is a block diagram showing an example of a circuit arrangement of the radio wave receiving apparatus according to the first exemplary embodiment.

FIG. 5 is a flowchart showing an example of a processing sequence of the radio wave receiving apparatus according to the first exemplary embodiment.

FIG. 6 is a flowchart showing another example of a processing sequence of the radio wave receiving apparatus according to the first exemplary embodiment.

FIG. 7 is a perspective view showing an example of the appearance of a radio wave receiving apparatus according to a second exemplary embodiment.

FIG. 8 is a perspective view showing the manner in which a rotational member shown in FIG. 7 is slid.

FIG. 9 is a block diagram showing an example of a circuit arrangement of the radio wave receiving apparatus according to the second exemplary embodiment.

FIG. 10 is a block diagram showing an example of a modification of the circuit arrangement of the radio wave receiving apparatus according to the second exemplary embodiment.

FIG. 11 is a perspective view showing an example of the appearance of a radio wave receiving apparatus according to a third exemplary embodiment.

FIG. 12 is a perspective view of an example of the structure of an angle-of-elevation changer shown in FIG. 11.

FIG. 13 is a block diagram showing an example of a circuit arrangement of the radio wave receiving apparatus according to the third exemplary embodiment.

FIG. 14 is a flowchart showing an example of a modification of a processing sequence of the radio wave receiving apparatus according to the third exemplary embodiment.

FIG. 15 is a perspective view showing an example of the appearance of a radio wave receiving apparatus according to a fourth exemplary embodiment.

FIG. 16 is a perspective view showing an example of the structure of an antenna leveling mechanism shown in FIG. 15.

FIG. 17 is a block diagram showing an example of a circuit arrangement of the radio wave receiving apparatus according to the fourth exemplary embodiment.

FIG. 18 is a flowchart showing an example of a processing sequence of the radio wave receiving apparatus according to the fourth exemplary embodiment.

### EXEMPLARY EMBODIMENT

The present invention will be described below with reference to the drawings.

### First Exemplary Embodiment

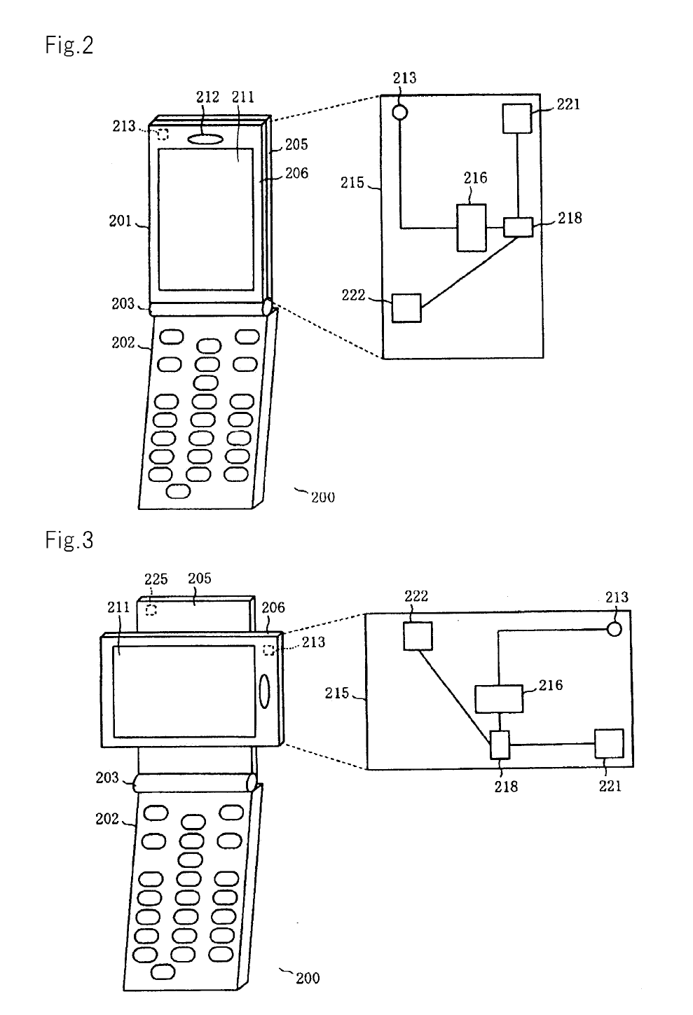

FIG. 2 is a perspective view showing an example of the appearance of a radio wave receiving apparatus according to a first exemplary embodiment, and FIG. 3 is a perspective view showing the manner in which a rotational member shown in FIG. 2 is rotated 90 degrees.

According to the first exemplary embodiment, a radio wave receiving apparatus for receiving radio waves from GPS satellites or the like comprises, by way of example, foldable cellular phone 200 including first body 201 and second body 202, shown in FIG. 2, which are openably and closably connected to each other by hinge mechanism 203.

First body 201 comprises base 205 connected to second body 202 by hinge mechanism 203 and rotational member 206 rotatably mounted on base 205.

Base 205 has a rotational shaft, not shown, near its center, and rotational member 206 is mounted on the rotational shaft so as to be rotatable about 90 degrees with respect to base 205, as shown in FIG. 3.

Display 211 and speaker 212 are mounted on rotational member 206. Rotational member 206 houses therein circuit board 215 supporting thereon first inverted-F antenna 221, second inverted-F antenna 222, antenna switcher 218, GPS controller 216, and magnetic sensor 213.

First inverted-F antenna 221 and second inverted-F antenna 222 comprise antennas whose radiation patterns indicative of directivities have different bearings. For example, first inverted-F antenna 221 and second inverted-F antenna 222 are disposed such that their directivities are perpendicular to each other, for example.

GPS controller 216 outputs various items of information required to calculate the present position of cellular phone 200, using GPS signals received by first inverted-F antenna 221 or second inverted-F antenna 222.

Antenna switcher 218 supplies the GPS signals received by first inverted-F antenna 221 or second inverted-F antenna 222 to GPS controller 216 according to an instruction from a controller, not shown, which controls overall operation of cellular phone 200.

Magnetic sensor 213 serves to detect whether or not rotational member 206 is rotated 90 degrees with respect to base 205. Magnetic sensor 213 is embedded near a corner of circuit board 215, which has a rectangular shape as shown in FIG. 2, that shares a shorter side of the rectangular shape with another corner where first inverted-F antenna 221 is disposed. Magnetic sensor 213 supplies its output signal to the controller. Magnet 225 is embedded in base 205 at a position that is aligned with magnetic sensor 213 when rotational member 206 is not rotated.

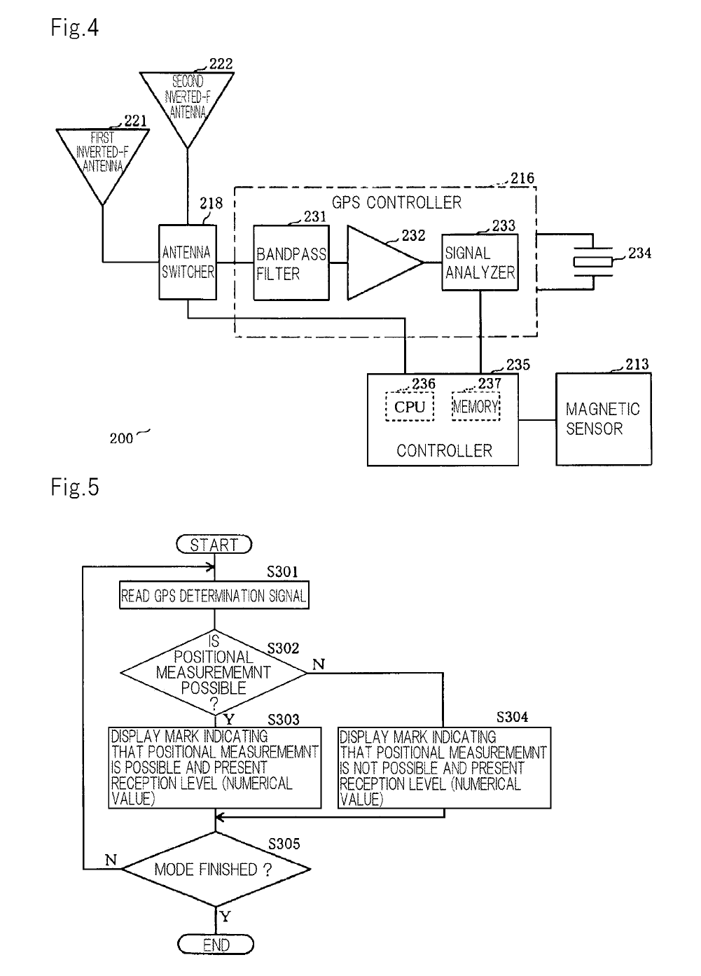

FIG. 4 is a block diagram showing an example of a circuit arrangement of the radio wave receiving apparatus according to the first exemplary embodiment.

As shown in FIG. 4, GPS controller 216 includes bandpass filter 231, low-noise amplifier 232, and signal analyzer 233.

Bandpass filter 231 limits the band of GPS signals received by first inverted-F antenna 221 or second inverted-F antenna 222 and output from antenna switcher 218.

Low-noise amplifier 232 amplifies the GPS signals output from bandpass filter 231 with an amplification factor indicated by controller 235. Signal analyzer 233 extracts various items of information required to calculate the present position (a process hereinafter referred to as positional measurement) from the GPS signals amplified by low-noise amplifier 232, outputs the extracted items of information to controller 235 which controls overall operation of cellular phone 200, determines whether or not the reception level of the GPS signals is a level capable of positional measurement, and outputs a GPS determination signal (digital signal) indicative of the determined result to controller 235. Signal analyzer 233 can determine whether or not the reception level of the GPS signals is a level capable of positional measurement based on the SNR (Signal to Noise Ratio) of the GPS signals, the error rate of the received data, or the like, for example.

The various items of information required to calculate the present position, which have been extracted from the GPS signals, and the GPS determination signal are supplied to controller 235, using an NMEA (National Marine Electronics Association) message which has a standard format for data transfer. The NMEA message includes information representative of the number of GPS satellites whose GPS signals can be received, the angles of elevation (in degrees) for the respective GPS satellites, and the SNR values (in decibel) of the received signals from the respective GPS satellites. Controller 235 can compare the SNR values from the respective GPS satellites and select a plurality of GPS signals to be used for positional measurement from the received signals.

Controller 235 includes a CPU (Central Processing Unit) 236 for executing processing sequences according to predetermined control programs and a memory 237 which store the control programs.

Controller 235 calculates the present position of its own apparatus using the information received from GPS controller 216. Controller 235 also determines whether or not rotational member 206 (FIG. 2) is rotated based on whether or not magnetic sensor 213 detects the magnetism of magnet 225 (FIG. 3). Specifically, when magnetic sensor 213 detects the magnetism, rotational member 206 is not rotated as shown in FIG. 2, and when magnetic sensor 213 does not detect the magnetism, rotational member 206 is rotated 90 degrees as shown in FIG. 3.

Controller 235 controls antenna switcher 218 based on whether or not magnetic sensor 213 detects the magnetism, thereby supplying the GPS signals received by first inverted-F antenna 221 or second inverted-F antenna 222 to GPS controller 216. At this time, controller 235 controls the amplification factor of low-noise amplifier 232 so that the level of the GPS signals supplied to signal analyzer 233 remains unchanged even when the antennas are changed, using the information indicative of the reception sensitivities of first inverted-F antenna 221 and second inverted-F antenna 222 which are stored in advance in memory 237. This is because even if first inverted-F antenna 221 and second inverted-F antenna 222 have identical characteristics and are angularly spaced accurately by 90 degrees within circuit board 215 (FIG. 2), the radiation patterns and reception sensitivities of first inverted-F antenna 221 and second inverted-F antenna 222 are different from each other under the influence of parts mounted on the surface of rotational member 206. The parts which affect the radiation patterns and reception sensitivities of first inverted-F antenna 221 and second inverted-F antenna 222 include display 211 and cells. The information of the radiation patterns and reception sensitivities is written in memory 237 at the time that cellular phone 200 is shipped from the factory.

The radiation patterns and reception sensitivities of the antennas may also be affected by electric products such as television receivers that are installed in houses and offices. Therefore, cellular phone 200 should preferably allow the user to store, in memory 237, the information of the radiation patterns and reception sensitivities of the antennas which correspond to positional information. When controller 235 calculates the present position from the GPS signals, controller 235 can read the information of the corresponding reception sensitivities, etc. from memory 237 based on the positional information, so that the read information can be utilized.

As shown in FIG. 4, cellular phone 200 includes quartz oscillator 234 which generates a clock signal that is supplied to signal analyzer 233, controller 235, and other circuits which require the clock signal.

FIG. 5 is a flowchart showing an example of a processing sequence of the radio wave receiving apparatus according to the first exemplary embodiment. FIG. 5 illustrates a processing sequence of cellular phone 200 in a direction setting mode which utilizes GPS functions.

When the user wants to check which bearing cellular phone 200 is to be directed in for better GPS utilization, the user sets cellular phone 200 in the direction setting mode by taking predetermined action. When cellular phone 200 is set in the direction setting mode, GPS controller 216 is supplied with electric power, allowing controller 235 to read an NMEA message including a GPS determination signal which is output from GPS controller 216 (step S301).

When controller 235 acquires the GPS determination signal from GPS controller 216, controller 235 determines whether or not the GPS signals are of a level capable of positional measurement, based on the GPS determination signal (step S302).

When rotational member 206 is in the state shown in FIG. 2, controller 235 selects the

GPS signals received by first inverted-F antenna 221 through antenna switcher 218. When rotational member 206 is in the state shown in FIG. 3, controller 235 selects the GPS signals received by second inverted-F antenna 222 through antenna switcher 218.

If the GPS signals are of a level capable of positional measurement, then controller 235 displays, on display 211, a mark (icon) indicating that GPS positional measurement is possible, and also displays a numerical value representative of the reception level of the GPS signals (step S303). Since the numerical value representative of the reception level of the GPS signals is displayed, the user can easily search for an optimum bearing and attitude for receiving the GPS signals more stably based on the displayed numerical values. The reception level may alternatively be displayed by other methods including a bar graph, color changes, etc.

If the GPS signals are not of a level capable of positional measurement, then controller 235 displays, on display 211, a mark (icon) indicating that GPS positional measurement is impossible, and also displays a numerical value representative of the reception level of the GPS signals (step S304). In this case, the user may change the bearing and attitude of cellular phone 200 to increase the reception level to a greater value.

When the processing of step S303 or step S304 is finished, controller 235 determines whether or not cellular phone 200 has been instructed to finish the direction setting mode (step S305). If cellular phone 200 has been instructed to finish the direction setting mode, then the processing sequence is ended. If cellular phone 200 has not been instructed to finish the direction setting mode, then control goes back to the processing of step S301, repeating steps S301 through S305.

The above processing sequence allows the user to easily determine a bearing and attitude optimum for positional measurement or a bearing and attitude capable of positional measurement when using the GPS functions provided by cellular phone 200.

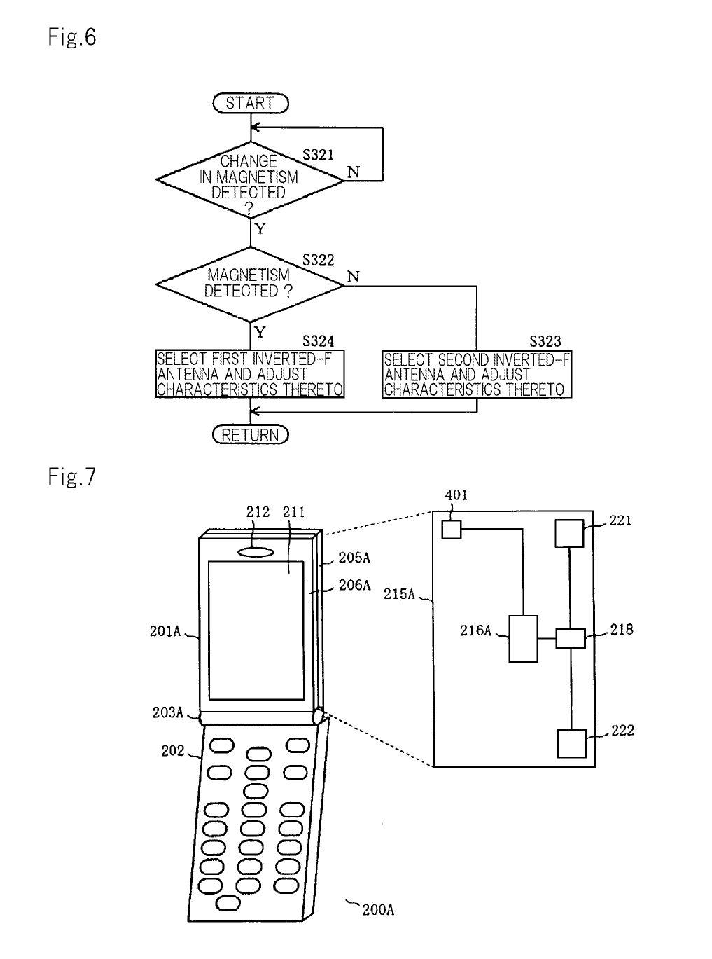

FIG. 6 is a flowchart showing another example of a processing sequence of the radio wave receiving apparatus according to the first exemplary embodiment. FIG. 6 shows a processing sequence of the cellular phone at the time the user has rotated the rotational member in order to use the GPS functions.

As shown in FIG. 6, controller 235 determines whether or not magnetic sensor 213 detects a change in magnetism (step S321). If magnetic sensor 213 detects a change in magnetism, then controller 235 determines whether magnetic sensor 213 detects magnetism after the change in magnetism (step S322).

If magnetic sensor 213 does not detect magnetism, then since it means that magnetic sensor 213 is spaced from magnet 225 embedded in base 205, rotational member 206 has been rotated 90 degrees with respect to base 205, as shown in FIG. 3. In this case, controller 235 sends a switching signal for selecting second inverted-F antenna 222 to antenna switcher 218, thereby outputting GPS signals received by second inverted-F antenna 222 to GPS controller 216. Controller 235 reads the information of the reception sensitivity of second inverted-F antenna 222 from memory 237, and changes the amplification factor of low-noise amplifier 232 to prevent the reception level for the GPS signals from changing greatly upon switching from first inverted-F antenna 221 to second inverted-F antenna 222 (step S323).

If magnetic sensor 213 detects magnetism in the processing of step S322, then since it means that magnetic sensor 213 is positioned near magnet 225 embedded in base 205, rotational member 206 has not been rotated with respect to base 205, as shown in FIG. 2. In this case, controller 235 sends a switching signal for selecting first inverted-F antenna 221 to antenna switcher 218, thereby outputting GPS signals received by first inverted-F antenna 221 to GPS controller 216. Controller 235 reads the information of the reception sensitivity of first inverted-F antenna 221 from memory 237, and changes the amplification factor of low-noise amplifier 232 to prevent the reception level for the GPS signals from changing greatly upon switching from second inverted-F antenna 222 to first inverted-F antenna 221 (step S324).

When the processing of step 5323 or step 5324 is finished, controller 235 enters a return loop (goes back to the processing of step S321), repeating steps S321 through S324.

The above processing allows cellular phone 200 to continuously receive GPS signals even when the user repeatedly rotates rotational member 206 so as to extend perpendicularly to base 205 and replaces rotational member 206.

According to the first exemplary embodiment, first inverted-F antenna 221 and second inverted-F antenna 222 which have different directional bearings are disposed on rotational member 206 of cellular phone 200, and are selected one at a time as an antenna to be used depending on the state of rotational member 206 with respect to base 205. Once the user has appropriately adjusted the direction and attitude of cellular phone 200, cellular phone 200 is free of the failure of not receiving GPS signals and of experiencing a significant drop in the reception level even when display 211 is rotated. Consequently, the operability of cellular phone 200 is prevented from being lowered.

With cellular phone 200 according to the first exemplary embodiment, since the antennas are not exposed, they are prevented from being damaged and do not present an obstacle to the layout of other parts such as display 211, etc. Therefore, a sufficient layout area is provided for those parts.

### Second Exemplary Embodiment

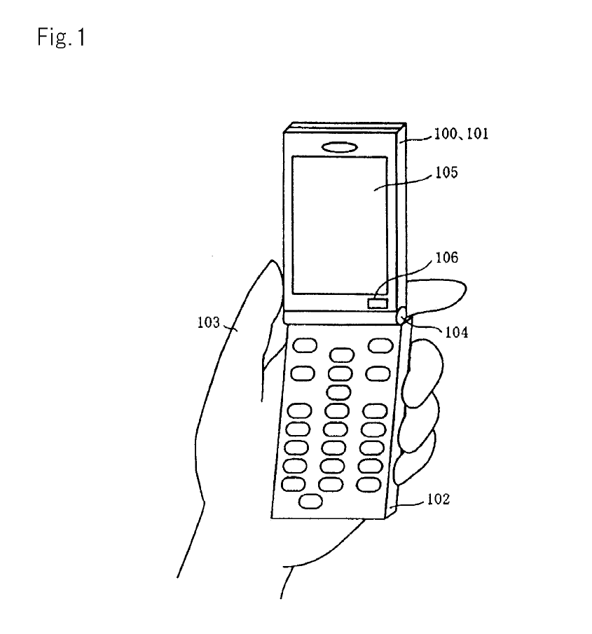

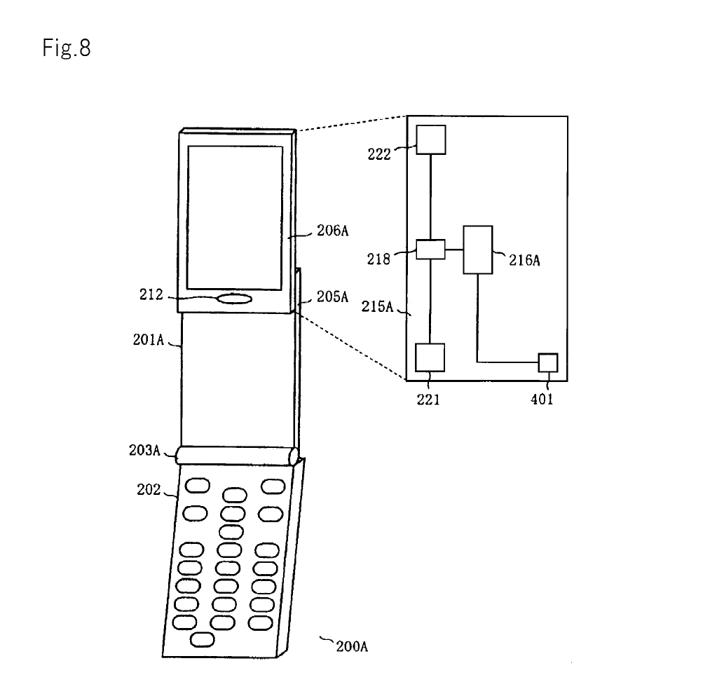

FIG. 7 is a perspective view showing an example of the appearance of a radio wave receiving apparatus according to a second exemplary embodiment, and FIG. 8 is a perspective view showing the manner in which a rotational member shown in FIG. 7 is slid. Those components shown in FIGS. 7 and 8 which are identical to the components of the cellular phone shown in FIGS. 1 and 2 are denoted by identical reference characters, and their description will be omitted hereinbelow.

According to the second exemplary embodiment, as with the first exemplary embodiment, a radio wave receiving apparatus for receiving radio waves from GPS satellites or the like comprises, by way of example, foldable cellular phone 200A including first body 201A and second body 202, shown in FIG. 7, which are openably and closably connected to each other by hinge mechanism 203A.

With cellular phone 200A according to the second exemplary embodiment, when rectangular display 211 is to be used vertically, rotational member 206A is disposed in a position overlying base 205A, as shown in FIG. 7. When display 211 is to be used at any desired angle, rotational member 206A is slid to a position spaced most widely from second body 202 on base 205A, as shown in FIG. 8, and rotational member 206A is rotated in that position. In FIG. 8, rotational member 206A is shown as being rotated 180 degrees.

Circuit board 215A according to the second exemplary embodiment includes accelerator sensor 401 in place of magnetic sensor 213 according to the first exemplary embodiment, and detects a rotational angle of rotational member 206A using accelerator sensor 401.

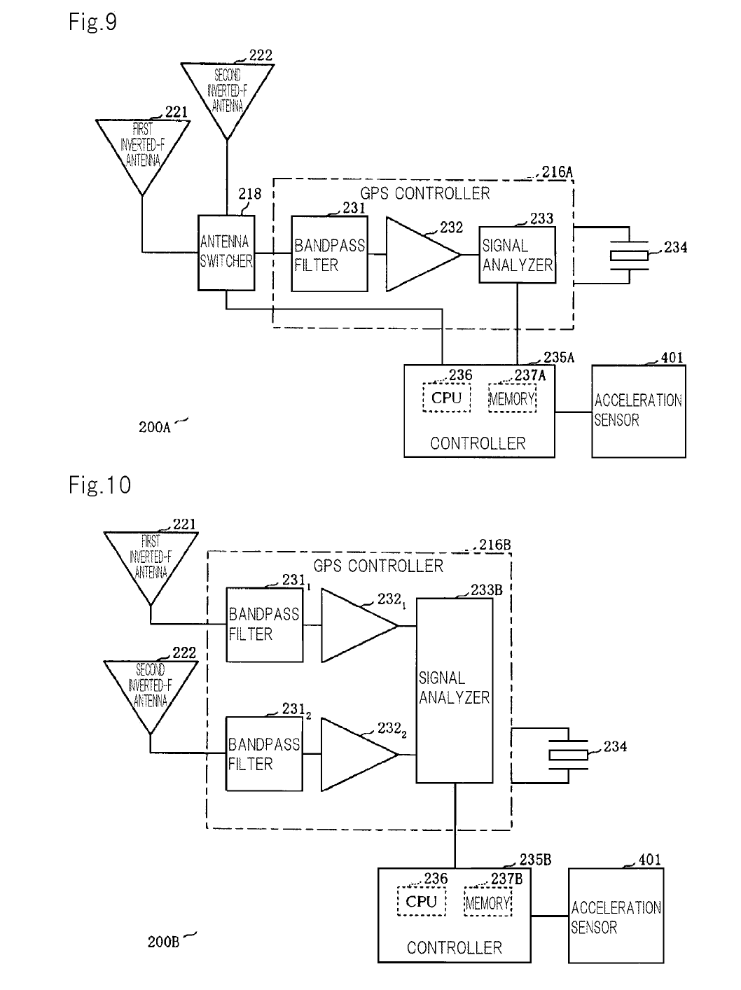

FIG. 9 is a block diagram showing an example of a circuit arrangement of the radio wave receiving apparatus according to the second exemplary embodiment. Those components shown in FIG. 9 which are identical to the components of the cellular phone shown in

FIG. 4 are denoted by identical reference characters, and their description will be omitted hereinbelow.

Controller 235A refers to the radiation patterns of first inverted-F antenna 221 and second inverted-F antenna 222 which are stored in advance in memory 237A, selects one of them to be used for positional measurement depending on the rotational angle of rotational member 206A which is detected by acceleration sensor 401, and controls antenna switcher 218 to supply GPS signals received by the selected antenna to GPS controller 216A.

Cellular phone 200 according to the first exemplary embodiment selects first inverted-F antenna 221 or second inverted-F antenna 222 as an antenna for receiving GPS signals to be supplied to GPS controller 216, depending on whether rotational member 206 is not rotated (FIG. 2) or is rotated 90 degrees (FIG. 3).

Cellular phone 200A according to the second exemplary embodiment selects first inverted-F antenna 221 or second inverted-F antenna 222 as an antenna for receiving GPS signals to be supplied to GPS controller 216A, based on the radiation patterns of first inverted-F antenna 221 and second inverted-F antenna 222. Therefore, depending on the radiation patterns of first inverted-F antenna 221 and second inverted-F antenna 222, the antennas may be switched over when the rotational angle of rotational member 206A is smaller than 90 degrees or greater than 90 degrees, for example.

FIG. 10 is a block diagram showing an example of a modification of the circuit arrangement of the radio wave receiving apparatus according to the second exemplary embodiment. Those components shown in FIG. 10 which are identical to the components of the cellular phone shown in FIG. 9 are denoted by identical reference characters, and their description will be omitted hereinbelow.

Cellular phone 200B shown in FIG. 10 has a configuration for performing diversity reception using first inverted-F antenna 221 and second inverted-F antenna 222.

GPS signals received by first inverted-F antenna 221 pass through bandpass filter 231₁ of GPS controller 216B, and are then amplified by low-noise amplifier 232₁. GPS signals received by second inverted-F antenna 222 pass through bandpass filter 231₂ of GPS controller 216B, and are then amplified by low-noise amplifier 232₂. The GPS signals amplified by low-noise amplifier 232₁, 232₂ are then analyzed by signal analyzer 233B.

Signal analyzer 233B analyzes the GPS signals received by first inverted-F antenna 221 and second inverted-F antenna 222 by using them at a ratio depending on the rotational angle of rotational member 206A. Memory 237B stores control programs necessary for a processing sequence to be performed by the modification of the second exemplary embodiment.

Since cellular phone 200B uses the GPS signals received by first inverted-F antenna 221 and second inverted-F antenna 222, the NMEA message includes antenna numbers corresponding to the GPS signals, as well as satellite numbers, the angles of elevation (in degrees), the azimuths (in degrees), the SNR values (in decibel), etc. as described above.

Cellular phone 200B shown in FIG. 10 does not require antenna switcher 218 shown in FIG. 9, but needs to have two sets of bandpass filters 231 and low-noise amplifiers 232. Consequently, the configuration shown in FIG. 10 may be adopted depending on the allowable power consumption and package size of cellular phones.

### Third Exemplary Embodiment

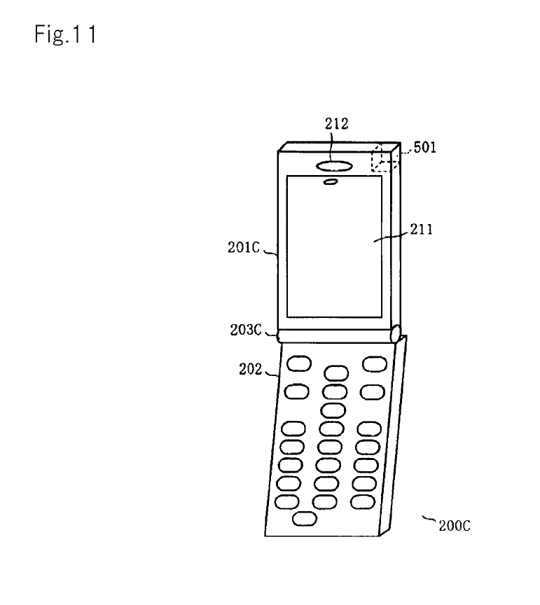

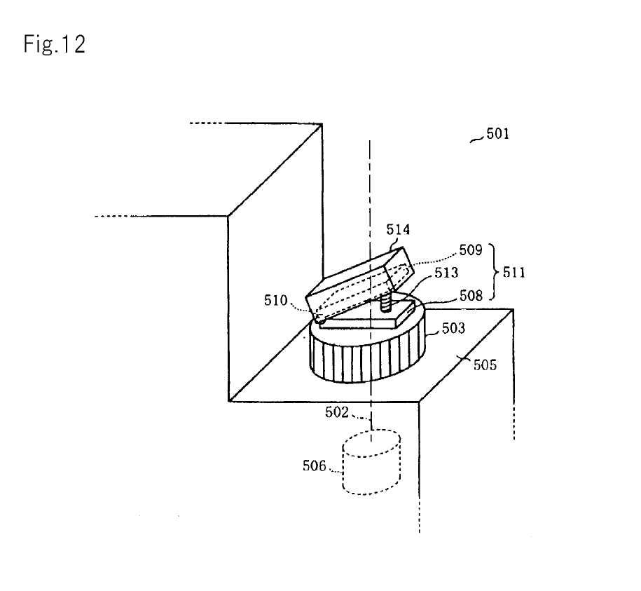

FIG. 11 is a perspective view showing an example of the appearance of a radio wave receiving apparatus according to a third exemplary embodiment, and FIG. 12 is a perspective view of an example of the structure of an angle-of-elevation changer shown in FIG. 11. Those components shown in FIG. 11 which are identical to the components of the cellular phone shown in FIG. 2 are denoted by identical reference characters, and their description will be omitted hereinbelow.

According to the third exemplary embodiment, as with the first exemplary embodiment and the second exemplary embodiment, a radio wave receiving apparatus for receiving radio waves from GPS satellites or the like comprises, by way of example, foldable cellular phone 200C including first body 201C and second body 202, shown in FIG. 11, which are openably and closably connected to each other by hinge mechanism 203C.

Cellular phone 200C has a configuration including angle-of-elevation changer 501 incorporated in a corner of first body 201C. Angle-of-elevation changer 501 is a device for correcting the bearing and angle of elevation of an antenna depending on the attitude of cellular phone 200C.

As shown in FIG. 12, angle-of-elevation changer 501 includes hollow disk 503 disposed on disk bearing surface 505. Disk 503 is coupled by shaft 502 to disk actuator 506 such as a motor or the like housed in the first body, and can be rotated about shaft 502. Opening and closing member 511 which comprises first rectangular cuboidal member 508 and second rectangular cuboidal member 509 which are connected to each other by hinge mechanism 510 is disposed on the upper surface of disk 503. First rectangular cuboidal member 508 has a lower surface fixed to the upper surface of disk 503.

First rectangular cuboidal member 508 has a vertically cylindrical through hole defined therein near an end thereof which is opposite to hinge mechanism 510. The hole has an internally threaded inner wall surface (not shown) threadedly engaged by screw 513. Screw 513 has an upper end held in abutment against the lower surface of second rectangular cuboidal member 509.

The upper end of screw 513 is magnetized and hence is magnetically attracted to the lower surface of second rectangular cuboidal member 509 which is made of iron. Screw 513 has a lower end connected to a screw actuator, not shown, housed in disk 503.

Second rectangular cuboidal member 509 is integrally formed with rectangular cuboidal antenna module 514 and has a lower surface exposed. Antenna module 514 houses therein a sealed patch antenna, not shown, disposed such that its main radiating surface lies parallel to the upper surface of antenna module 514. The patch antenna may be fixed to the upper surface of antenna module 514 or may be fixed to the upper surface of second rectangular cuboidal member 509. Second rectangular cuboidal member 509 and the upper end of screw 513 are magnetically attracted to each other in order to cause antenna module 514 to follow the vertical movement of screw 513 at all times.

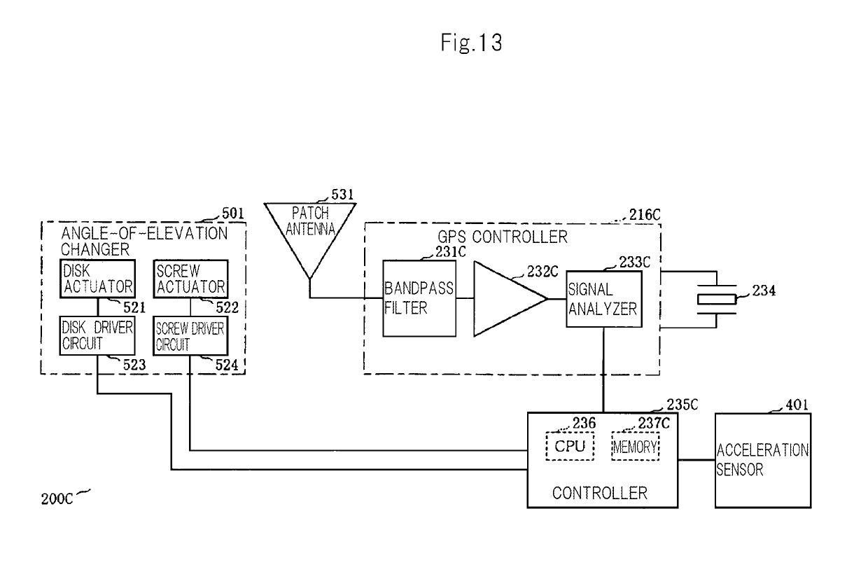

FIG. 13 is a block diagram showing an example of a circuit arrangement of the radio wave receiving apparatus according to the third exemplary embodiment.

As shown in FIG. 13, angle-of-elevation changer 501 includes disk actuator 521 for rotating disk 503 shown in FIG. 12 and screw actuator 522 for rotating screw 513. Disk driver circuit 523 for energizing disk actuator 521 is connected to disk actuator 521, and screw driver circuit 524 for energizing screw actuator 322 is connected to screw actuator 522.

Disk driver circuit 523 and screw driver circuit 524 are supplied with control signals for controlling operation of disk actuator 521 and screw actuator 522.

Controller 235C is supplied with a detected value from acceleration sensor 401, and determines an angle of tilt of disk bearing surface 505 shown in FIG. 12 from the detected value. GPS signals received by patch antenna 531 housed in antenna module 514 shown in

FIG. 12 pass bandpass filter 231C of GPS controller 216C, are then amplified by low-noise amplifier 232C, and analyzed by signal analyzer 233C.

As described above, patch antenna 531 can be regarded as an omnidirectional antenna with respect to the directions of one of its planar surfaces (main radiating surface). With cellular phone 200C shown in FIG. 11, however, the main radiating surface of patch antenna 531 is inclined with respect to the horizontal plane and its bearing is also changed depending on the attitude of cellular phone 200C.

Controller 235C actuates disk 503 and screw 513 of angle-of-elevation changer 501 depending on the angle of tilt of disk bearing surface 505 which is detected by acceleration sensor 401 for thereby controlling the tilt of angle of antenna module 514 to make patch antenna 531 horizontal. Controller 235C includes CPU 236 for performing a processing sequence according to control programs stored in memory 237C.

According to the third exemplary embodiment, since patch antenna 531 is kept horizontal even when the attitude of cellular phone 200C is changed, cellular phone 200C can stably receive GPS signals.

In the third exemplary embodiment described above, patch antenna 531 is controlled so as to be kept horizontal. However, if memory 237 stores in advance the information of the azimuths and angles of tilt of the plural GPS satellites, then the antenna can be oriented toward each of the GPS satellites using the stored information. In this case, patch antenna 531 may be replaced with an antenna having a relatively strong directivity, such as an inverted-F antenna, for receiving radio waves from the GPS satellites.

If a cellular phone is capable of receiving GPS signals from a plurality of GPS satellites and the present position of the cellular phone is calculated from desired GPS signals selected from the received GPS signals, then it is possible to perform a control process for presetting a given threshold value for the SNR values of the GPS signals and selecting those GPS signals whose SNR values are greater than the threshold value.

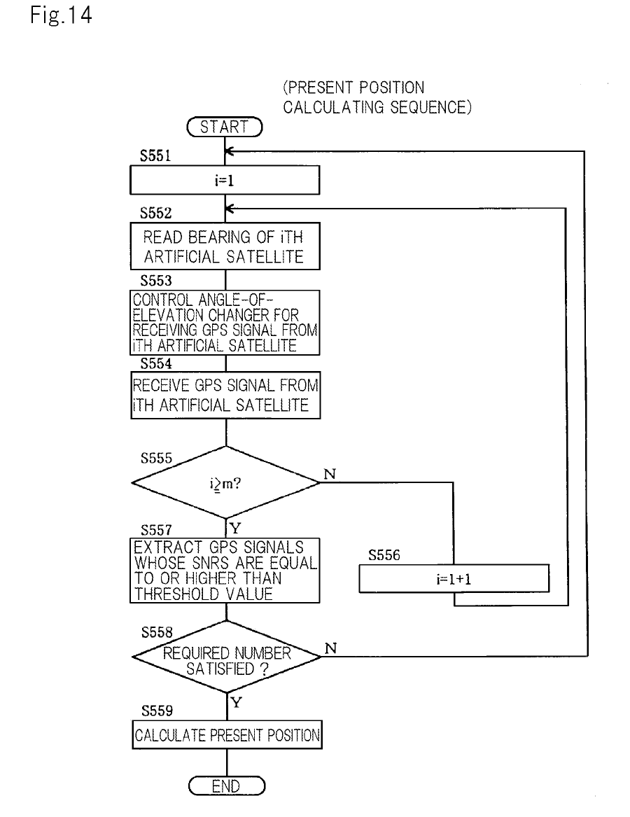

FIG. 14 is a flowchart showing an example of a modification of a processing sequence of the radio wave receiving apparatus according to the third exemplary embodiment. FIG. 14 shows a processing sequence for calculating the present position of the radio wave receiving apparatus using GPS signals received by a highly directional antenna such as an inverted-F antenna or the like.

The processing sequence shown in FIG. 14 is for a cellular phone having an inverted-F antenna that is employed in place of patch antenna 531 shown in FIG. 13. Other structural details of the cellular phone are the same as those of cellular phone 200C shown in FIG. 13.

As shown in FIG. 14, controller 237C initializes the value of a variable i which is indicative of the number of m GPS satellites that exist at the time, to “1” (step S551).

Then, controller 237C reads the information of the azimuth of the ith GPS satellite from memory 237C (step S552). It is assumed that memory 237C stores in advance the data (calculated results) of the respective azimuths of the GPS satellites.

Controller 237C controls angle-of-elevation changer 501 to bring the directivity of the antenna into alignment with the ith GPS satellite (step S553), and receives a GPS signal from the ith GPS satellite (step S554).

Then, controller 237C determines whether or not the value of the variable i is equal to or greater than “m” (step S535). If the value of the variable i is smaller than “m”, then controller 237C adds “1” to the value of the variable i (step S536). Then, control returns to the processing of step S552, repeating steps S552 through S555.

If the value of the variable i is equal to or greater than “m”, then controller 237C extracts GPS signals whose SNR values are greater than the preset threshold value from among the GPS signals received from the first through mth GPS satellites (step S557).

Then, controller 237C determines whether or not the total number of the GPS signals extracted in step S557 is equal to or greater than a number that is required in calculating the present position (step S558). If the total number of the extracted GPS signals is equal to or greater than the number that is required, then controller 237C calculates the present position using the GPS signals extracted in step S557 (step S559). Then, the processing sequence is ended.

If angle-of-elevation changer 501 is not well controlled due to poor radio-wave environments, noise, etc., then the total number of GPS signals whose SNR values are greater than the threshold value may be smaller than the number that is required in calculating the present position. In such a case, controller 237C goes back to the processing of step S551, repeating steps S551 through S558.

### Fourth Exemplary Embodiment

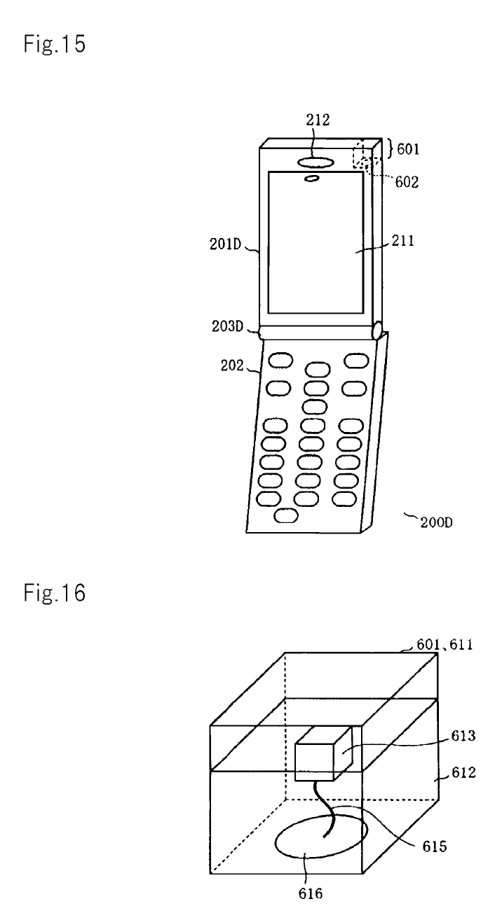

FIG. 15 is a perspective view showing an example of the appearance of a radio wave receiving apparatus according to a fourth exemplary embodiment, and FIG. 16 is a perspective view showing an example of the structure of an antenna leveling mechanism shown in

FIG. 15. Those components shown in FIG. 15 which are identical to the components of the cellular phone shown in FIG. 2 are denoted by identical reference characters, and their description will be omitted hereinbelow.

According to the fourth exemplary embodiment, as with the first exemplary embodiment through the third exemplary embodiment, a radio wave receiving apparatus for receiving radio waves from GPS satellites or the like comprises, by way of example, foldable cellular phone 200D including first body 201D and second body 202, shown in FIG. 15, which are openably and closably connected to each other by hinge mechanism 203D.

Cellular phone 200D shown in FIG. 15 has a configuration including antenna leveling mechanism 601 incorporated in a corner of first body 201D. Antenna leveling mechanism 601 is a device for correcting the bearing and angle of elevation of an antenna depending on the attitude of cellular phone 200C. Cellular phone 200D shown in FIG. 15 is shown as lacking antenna leveling mechanism 601 in first body 201D, but as including body-side connector 602 that is connected to antenna leveling mechanism 601 and disposed in the region where antenna leveling mechanism 601 is installed.

As shown in FIG. 16, antenna leveling mechanism 601 includes a rectangular cuboidal case 611 containing liquid 612 such as alcohol, viscous oil, or the like and antenna module 613 flowing in liquid 612.

Antenna module 613 includes a patch antenna, not shown, embedded therein such that its main radiating surface lies parallel to the upper surface of antenna module 613.

Coaxial cable 615 is connected to the patch antenna and extends from the lower surface of antenna module 613 into liquid 6122. Coaxial cable 615 has an end connected to module-side connector 616.

Antenna module 613 floats in liquid 612 so that it is not affected by coaxial cable 615 and has an upper surface lying substantially flush with the surface of liquid 612. When cellular phone 200D is still, the surface of liquid 612 remains horizontal at all times.

Irrespective of the attitude of cellular phone 200D shown in FIG. 15, antenna module 613 is kept horizontal at all times as long as cellular phone 200D is still. Therefore, the patch antenna disposed in antenna module 613 is capable of easily receiving GPS signals.

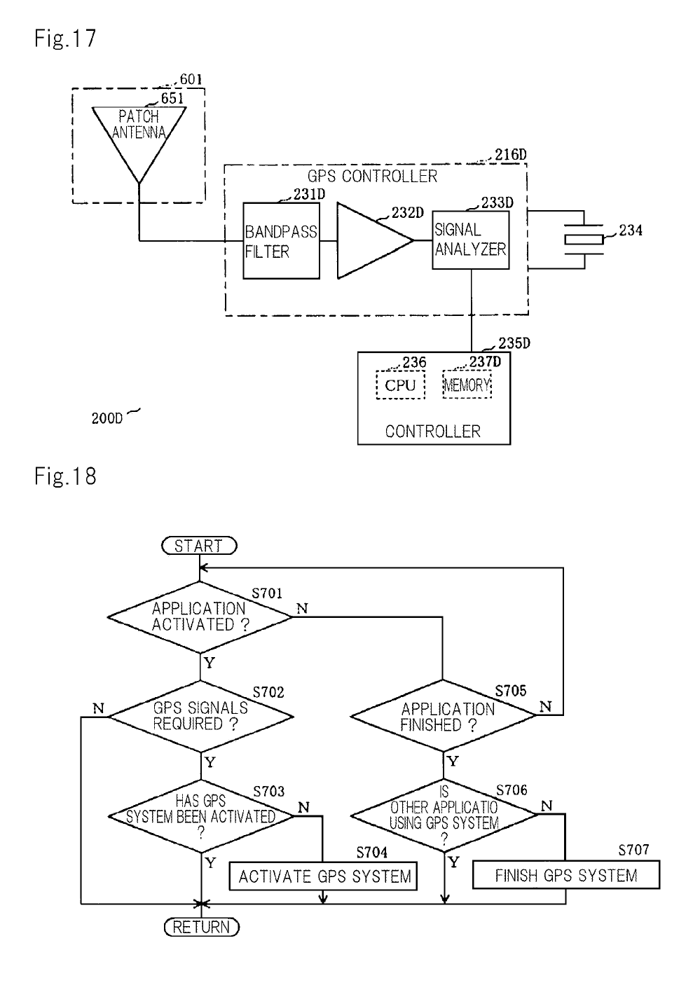

FIG. 17 is a block diagram showing an example of a circuit arrangement of the radio wave receiving apparatus according to the fourth exemplary embodiment.

As described above, when cellular phone 200D according to the fourth exemplary embodiment is still, patch antenna 651 housed in antenna leveling mechanism 601 is kept horizontal. Therefore, unlike the first exemplary embodiment through the third exemplary embodiment, it is not necessary to detect the azimuth and attitude of cellular phone 200D with the sensor and to switch between the antennas and control the azimuth and the angle of elevation of the antennas with controller 235D.

With cellular phone 200D according to the fourth exemplary embodiment, it is necessary to calculate the present position of cellular phone 200D using the received GPS signals while antenna module 613 floating in liquid 612 is in a stable attitude. Therefore, controller 235D attempts to detect a change in the attitude of cellular phone 200D with a sensor or the like, not shown. If controller 235D detects a change in the attitude of cellular phone 200D, then controller 235D starts positional measurement using GPS signals after vibrations of the surface of liquid 612 which have been caused by the change in the attitude are reduced to a certain level.

On cellular phones, various pieces of application software are activated when instructed by the user or according to certain control programs. Of these pieces of application software, some utilize GPS for assisting the user in reaching a destination, for example. Information indicating which application software utilizes GPS is recorded in advance in a memory of a controller.

A processing sequence for controlling the supply and stop of electric power to circuits that are used in GPS functions according to activated application software will be described below with reference to FIG. 18.

FIG. 18 is a flowchart showing an example of a processing sequence of the radio wave receiving apparatus according to the fourth exemplary embodiment.

As shown in FIG. 18, controller 235D monitors whether or not there is an instruction to activate application software (step S701). If there is an instruction to activate application software, then controller 235D refers to the information stored in memory 237D to determine whether or not the application software utilizes a GPS (step S702). If the activated application software does not utilize a GPS, then controller 235D enters a return loop, starting the processing sequence from step S701 again.

If the activated application software utilizes GPS, then controller 235D determines whether or not electric power has already been supplied to all circuits including GPS controller 216D (GPS system) used in GPS functions (step S703). If electric power has already been supplied to the GPS system according to other application software which utilizes a GPS, then controller 235D enters a return loop (going back to step S701).

If electric power has not been supplied to the GPS system, then controller 235D supplies electric power to the GPS system, and acquires GPS signals for the activated application software (step S704). Since electric power is supplied to the GPS system only when necessary, the power consumed by cellular phone 200D (FIG. 15) can be saved.

If there is no instruction to activate application software in the processing of S701, then controller 235D determines whether or not there is an instruction to finish application software (step S705). If there is no instruction to finish application software, then control goes back to the processing of step S701.

If there is an instruction to finish application software, then controller 235D determines whether or not other application software which utilizes a GPS has been activated (step S706). If other application software which utilizes a GPS has been activated, then controller 235D enters a return loop.

If other application software which utilizes GPS has not been activated, then the supply of electric power to the circuits of the GPS system is stopped (step S707).

According to the fourth exemplary embodiment, since path antenna 651 is kept horizontal at all times even when the attitude of cellular phone 200D is changed, cellular phone 200D can stably receive GPS signals.

Furthermore, since the GPS system is activated only when a GPS is utilized in interlinked relation to the activation/inactivation of application software, the power consumed by cellular phone 200D can be saved.

In the first exemplary embodiment through the fourth exemplary embodiment and modification thereof described above, a cellular phone has been illustrated as an example of the radio wave receiving apparatus. However, the present invention is also applicable to other portable terminals such as PHS sets, PDAs, etc.

In the first exemplary embodiment through the fourth exemplary embodiment and modification thereof described above, furthermore, an inverted-F antenna has been illustrated as the directional antenna and a patch antenna has been illustrated as the omnidirectional antenna. However, the directional antenna and the omnidirectional antenna are not limited to those antennas. If various other antennas are used, then optimum configurations thereof may be selected depending on the extent of their directivity.

In the first exemplary embodiment through the fourth exemplary embodiment and modification thereof described above, moreover, an apparatus for receiving radio waves from GPS satellites has been illustrated as an example of the radio wave receiving apparatus. However, the present invention is also applicable to an apparatus for receiving radio waves from a relatively high altitude.

Although the present invention has been described above with respect to the exemplary embodiments, the present invention is not limited to the exemplary embodiments described above. Various changes that can be understood by those skilled in the art can be made in the configurations and details of the present invention within the scope of the invention.

The present application claims priority based on Japanese patent application No. 2007-237425 filed on Sep. 13, 2007, and incorporates herein the entire disclosure thereof by reference.

1. A radio wave receiving apparatus comprising:
a sealed case containing a liquid therein, said sealed case being disposed in an apparatus body; and
a planar antenna floating in said liquid such that a main radiating surface lies parallel to the surface of said liquid.

2. A radio wave receiving apparatus comprising:
an antenna holding member for holding an antenna such that a bearing and an angle of tilt thereof are variable, said antenna holding member being disposed on an apparatus body;
a detector for detecting a change in the attitude of said apparatus body;
a controller for controlling the attitude of said antenna holding member depending on the attitude of said apparatus body detected by said detector,
said antenna comprises a planar antenna having a wide directivity; and
said controller controls the attitude of said antenna holding member to make a main radiating surface of said antenna horizontal,
wherein said antenna comprises a patch antenna.

3. The radio wave receiving apparatus according to claim 1, wherein said antenna comprises a patch antenna.
